(19) United States
(12) Patent Application Publication
(10) Pub. No.: US 2015/0128427 A1
(43) Pub. Date: May 14, 2015

(54) SCISSORS WITH REPLACEMENT BLADES AND BALL BEARINGS

(71) Applicant: Buck Knives, Inc., Post Falls, ID (US)

(72) Inventors: Eric P. Linn, Post Falls, ID (US); Justen L. Bock, Spokane, WA (US)

(21) Appl. No.: 14/539,883

(22) Filed: Nov. 12, 2014

Related U.S. Application Data
(60) Provisional application No. 61/903,304, filed on Nov. 12, 2013.

(51) Int. Cl. B26B 13/04; B26B 13/28; B26B 13/06

(52) U.S. Cl. CPC B26B 13/04; B26B 13/06; B26B 13/28
USPC 30/260; 29/446

(57) ABSTRACT

A scissors tool having removable replacement blades and bearings in an arcuate bearing path disposed to stiffen the pivot and bias the blades together with greater inter-blade pressure at the cutting point. In some embodiments, the scissors tool has flexible arms which increase said cutting point edge pressure and provide that little to no gap forms between the blades proximate to and behind the cutting point.

### CROSS-REFERENCES TO RELATED APPLICATIONS

The present application claims the benefit of U.S. Provisional Application No. 61/903,304 (Attorney Docket No. 88791-884002 (011910US)), filed on Nov. 12, 2013, the full disclosure of which is incorporated herein by reference.

### BACKGROUND

Scissors are a well known tool. Typically scissors have a pair of handles attached to blades opposite a pivot. When the handles are closed, the blade edges bypass each other in a scissor action for cutting of material in shear.

Scissors are a preferred tool for many tasks because of their versatility, simplicity and ease of use; however, they are often weak when used to cut strong or flexible materials such as thick fabric, wire, cardboard, or heavy fishing line and braided line in particular; and they may wear quickly when used for such demanding tasks. Specialized cutting tools such as wirecutters or shears are often preferred over scissors for difficult jobs, because those tools will generally develop cutting force beyond what is possible with conventional scissors, either by cutting the material through compression (as in wirecutters), or by restraining the cutting surfaces to very short distance from the fulcrum as compared to the length of the handles (as in shears). However, such tools lack the versatility of scissors, and a scissors tool that could generate high cutting power without the aforementioned drawbacks would possess great practical utility.

Prior art patents on scissors with replaceable blades are as follows: U.S. Pat. No. 5,355,585 U.S. Pat. No. 1,885,754 U.S. Pat. No. 1,628,856 U.S. Pat. No. 1,609,638 U.S. Pat. No. 1,696,323 U.S. Pat. No. 3,548,496 U.S. Pat. No. 2,677,179 U.S. Pat. No. 2,377,906 U.S. Pat. No. 3,170,237.

### BRIEF SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Embodiments herein are directed to a scissors tool having, for each arm, a concave, curved blade pocket for receiving a replaceable blade. In embodiments, the blades come into contact at an orientation that is parallel to the shear plane and to one another. In addition, embodiments of scissors described herein include a rigid pivot complex that biases the blades together with high force and minimal deformation of the pivot.

The replaceable blades can be made with various edge angles, serrations and materials for specific tasks, and are easily replaced when they become dull. The blades described in embodiments are flat for ease of manufacture and are assembled into a concave pocket on each of the scissors arms, and then flexed into a bent or bowed configuration by the tightening of a screw near the blade midpoint. Thus, each blade is curved in the direction of a plane where it abuts the other blade, which is also termed the “draw”. The curvature of the scissor arms biases the blades into contact at a cutting point, and a combination of this curvature, elastic deformation of the scissor arms, and the stiffness of the pivot provides high pressure at this point of contact. High contact pressure persists in the full range of motion of the scissors from open to closed.

Furthermore, and unlike conventional high-end scissors, embodiments possess blades with draw, but no helical shape (or twist). Thus, at the point of contact, the blades are parallel to one another and also parallel to the shear plane.

The rigidity of the pivot in combination with elastic deformation of the scissor arms minimizes gap between the blades in the region between the point of contact and the pivot, causing the blades to remain substantially parallel in the longitudinal direction when closed. Flexure of the blades maintains this parallel orientation and thus minimizes the gap between the blades behind the cutting point throughout the entire cutting action. This tight tolerance between the blades assists in the cutting action because the blades more accurately come into contact with the material along the ideal cutting plane, and are less likely to separate or to rotate and trap the material between the blades. Thus, embodiments herein described avoid some of the pitfalls of conventional designs, such as wasted force in compression or irregular deformation in the cut material.

The rigidity of the pivot is provided in embodiments by reinforcement through ride bearings provided between the scissor arms, at a region between the pivot and the handle. Ball bearings are assembled into an arcuate bearing path or groove adjacent to the pivot, near the handles and opposite the blades, which is placed in compression to lever the blades tightly together. Thus, the force on the bearings counteracts the force exerted between the blades by contact pressure. This bearing complex can also act as stops when the scissors are open.

In some embodiments, the rigidity of the pivot is further reinforced by the provision of bearings in a circular track about the fastener. These bearings reduce friction as the blades rotate, help to prevent the opening and closing action from loosening the pivot fastener, and further increase the resistance of the pivot to orthogonal stress. Furthermore, with these effects, it is possible to use a stiffer pivot fastener and to place it under greater tension that would otherwise be feasible. In alternative embodiments, the bearings about the fastener may be replaced by washers, which may also reduce friction in addition to providing rigidity, and may be composed of conventional or low-friction materials. Finally, embodiments can also provide a selection of additional features, including: a pliers jaw at the tip of the scissors arms, a hanging loop, a variety of handle types including at least basic and looped handles, a bottle opener, a wire crimper, and others.

For a fuller understanding of the nature and advantages of the present invention, reference should be made to the ensuing detailed description and accompanying drawings

### BRIEF DESCRIPTION OF THE DRAWINGS

FIG. 1 is an exploded view of an embodiment of the scissors tool assembly.

FIG. 2 is a left view of the same embodiment shown in FIG. 1 with the blades opened but without hidden detail.

FIG. 3 is a left view as in FIG. 2 of the same embodiment with hidden detail shown, including pivot bearings, ride bearings, and replacement blade attachment pockets.

FIG. 4A is a left plan view of a replacement blade as incorporated in the above figures.

FIG. 4B is a front plan view of the blade shown in FIG. 4A.

FIG. 4C is a top view of the blade shown in FIG. 4A.

FIG. 4D is an enlarged side view of a portion of a replacement blade edge.

FIG. 5 is an assembly top view of a replacement blade and receiving socket on one scissor/plier arm, in accordance with the same embodiment detailed in the above figures.

FIG. 6 is a left view of a replacement blade mounted in a receiving socket in one scissor/plier arm.

FIG. 7A is a top section view of the scissors assembly when the scissors tool is closed.

FIG. 7B is a top section view of the pivot assembly of the scissors tool when closed.

FIG. 8A is a front section view of the scissors assembly with edges coming into contact with each other, showing a cross-section at a midpoint on the blades.

FIG. 8B is a front section view of the scissors assembly with blades in the closed position, at the same mid-point as shown in FIG. 8A.

FIG. 9 is an exploded view of an alternate embodiment of the scissors tool assembly.

FIG. 10 is left view of an alternate embodiment of the scissors tool assembly with the blades closed.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

A popular design for scissors is a configuration having rigid arms which are both structural and cutting members. These arms have cutting edges that are slightly inclined toward one another at the distal end, such that the scissors fit together very tightly when in the closed position and less tightly when open, thus bringing the blades into direct contact only at the cutting point and leaving a gap in the region between the cutting point and pivot. In such designs, the blades tend to be rigid such that no detectable bending occurs in the blade arms, but slight bending often occurs in the pivot joint due to the pressure between the blades at the contact point, especially when in the closed position. Although such designs may be adequate to cut many thin or soft materials such as paper, fabric, or hair; cutting stronger materials can create significant problems. The blades ideally contact the material at points on two sides which coincide with a shear plane through the material, such that most of the force exerted on the handle is translated through the blades into shear in the material along that plane. Under ideal conditions, a minimal amount of force is translated into non-shear deformation or rotation of the material, but limitations inherent in conventional designs tend to disrupt this objective.

Among high-end, conventional scissors, the arms tend to have both an inward curvature (draw) and also a helical curvature along the length of the blade (twist) with the result that, at the point of contact of the blades, the blade surfaces are not perfectly parallel to the cutting plane. Typical twist angles vary in the neighborhood of a few degrees. This twist allows blades to achieve contact point pressure along the whole length of the blade, but leads to the creation of a gap behind the point of contact, and shifts the points of contact of the blades (against the material to be cut) some small but significant distance from the ideal shear plane, along any object which possesses a nonnegligible thickness.

Cutting hard materials with the distal end of conventional scissors is difficult due to the loss of mechanical advantage at distance from the fulcrum, but cutting hard materials with the proximal end is problematic as well. When fully open, conventional scissors tend to have relatively low pressure between the cutting edges at their contact point due to the geometry of the rigid cutting arms and looseness of the pivot point, which can cause a substantial gap between the blades. Due to these characteristics, conventional scissors blades are prone to separate under stress and to contact the material at a substantial distance away from the ideal shear plane. The aforementioned traits limit the usefulness of conventional scissors by making possible several malfunctions, including but not limited to trapping of material between the blades where separated and waste of cutting force by misalignment of the cutting edges at their respective points of first contact with the object to be cut.

Certain materials such as braided cord or fishing line, such as high-tensile fishing line or other outdoor-purposed rope, string or cord, pose particular challenges to conventional scissors. Braided line combines several of the features that make materials particularly difficult to cut because the material deforms under stress, is thicker than its component parts, and is composed of very fine individual threads or cords which may easily deform and become trapped or pressed between the blades. Cutting braided cord often requires multiple passes with conventional scissors, and trapped material can cause the blades to become stuck or to separate, potentially damaging the pivot and making the scissors more difficult to open.

These limitations have been partially overcome by various techniques in the use and design of scissors: for instance, scissors may be designed to create additional edge pressure by increasing the angle between the blades in the longitudinal direction (also called the draw); however, this design element comes with several costs. Such costs include: creating substantial space between the blades behind the contact point in which material can become stuck, shifting the points of first contact between blades and the material to be cut away from the ideal shear plane which can exacerbate a risk of putting cut objects under pressure or in torsion rather than in simple shear, and promoting twisting or irregular deformation of the material. Alternatively, greater cutting edge bias can be achieved with conventional scissors manually by manipulating the handles in a direction orthogonal to their ordinary travel, but this technique can be uncomfortable or difficult depending on the strength of the user, and tends to reduce the force that a user can apply to the handles in the cutting direction. Angling a straight cutting blade tends to increase the gap between the blades adjacent to the cutting point, and tends to promote a mismatch at the point of contact which results in a greater portion of the cutting force being misdirected into non-shear deformation. A twisted or helical blade geometry (also called the twist) is common in conventional, high-end scissors, and can help to create contact pressure between the blades at the point of contact without necessitating significant deformation in either the scissor arms or in the pivot; but twist also creates a gap between the blades and causes the cutting action to occur slightly outside of the ideal shear plane.

Having sharp or serrated blades helps the scissors to grip the material along the cutting plane, reducing the incidence of blade separation and unintended rotation. However, scissors incorporating sharpened and serrated blades are more expensive and prone to wear, and often require expensive refinishing or grinding by a skilled artisan. Furthermore, in high-end scissors with tight clearances or with complex mechanical parts, the process of disassembly and reassembly can be difficult for an end user. Among scissors that generate high edge pressure, wear on blades can necessitate frequent replacement or refurbishment. Replaceable blades can be a cost-effective solution to these issues. Replacement blades may be composed of the same or a different material than the rigid body of the scissors to which they are attached, and may be curved in manufacture, or may be straight and then bent by attachment to the scissors.

### DETAILED DESCRIPTION OF THE DRAWINGS

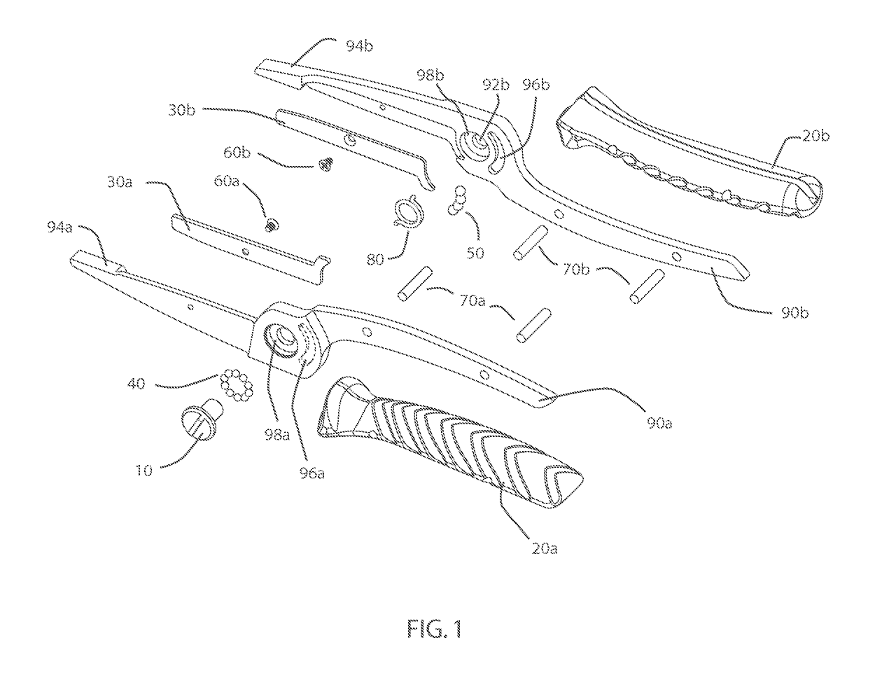

FIG. 1 shows a scissors tool in an exploded assembly view in accordance with embodiments. Shown are the arms 90a and 90b that have handles 20a and 20b attached by pins 70a and 70b. Although the textured structures or grips that form the handles 20a and 20b are labeled as “handles,” the term “handle” may be used to refer to any structure designed to be held by the user. Thus, “handle” may include not only the textured grip but also the structure that includes the underlying arm section, pins, and other assembly parts supporting the grip. Typically, “handle” will not extend to the pivot fastener 10.

For purposes of clarity, the entire assembly in various embodiments may be described as having a “blade” end and a “handle” end, separated by a pivot. In the embodiment shown in the drawings, the pivot is a pivot fastener 10 that passes through the arms 90a and 90b to join them. Other terms for the pivot may include the joint or fulcrum, and other terms for the blade end may include the distal end or tip. In embodiments, the arms 90a and 90b are each formed of a single part which extends through the entire handle end, through the pivot, to the distal tip of the blade end. Thus, depending on context, the terms “handle end”, “pivot”, and “blade end” may refer to sections of the same underlying parts, arms 90a and 90b, supporting the handles, pivot fastener, and blades, respectively.

In accordance with embodiments, the arms 90a and 90b have pockets located at regions of the arms between the pivot 10 and the distal tip of the blade end, opposite the handles 20a and 20b from the pivot fastener 10. The pockets are concave, and have threaded holes such that the blades 30a and 30b may be attached to the arms 90a and 90b by removable screws 60a and 60b respectively, inserted through the blades near the midpoint of the blades. The blades 90a and 90b are straight in their disassembled state, and are bowed into a curvature by tightening into the pockets of the curved arms 90a and 90b. In embodiments, one or more of the blades may have a smooth, serrated or microserrated leading edge; or one blade may have a serrated edge and the other may have a smooth edge. Blades may have various edge angles in accordance with embodiments, and may be composed of various different materials, depending on the purpose of the particular blades.

Each arm has an arcuate groove 96a and 96b proximate to the pivot on the handle end, between the pivot fastener 10 and the handles 20a and 20b, wherein each groove is an arc with a center of the arc at the pivot fastener 10. The two arcuate grooves face each other when the arms are assembled. One or more ride bearings 50 are assembled into the tracks 96a and 96b when the arms are joined at the pivot. A coil spring 80 is shown which is mounted about the pivot fastener 10. Ends of the coil spring engage the two arms and bias the scissors arms 90a and 90b in an open position. Also shown is a pivot fastener 10 and pivot bearings 40 received in a circular channel 98a about the pivot fastener, which connects arm 90a to arm 90b by attachment through arm 90a to pivot socket 92b on arm 90b. Although in this figure the pivot fastener 10 is shown as a smooth flat-head screw, persons of skill in the art will appreciate that fastening may be achieved by other means. In various other embodiments, the fastener may be a bolt and nut assembly; and fasteners may be locking or configured for ease of disassembly. The cutting blades 30a and 30b rotate with respect to one another about the pivot fastener 10 between an open position and a closed position. In FIG. 1, the assembly is oriented in the closed position. In accordance with embodiments, pliers ends 94a and 94b are shown at the distal/blade end of the tool.

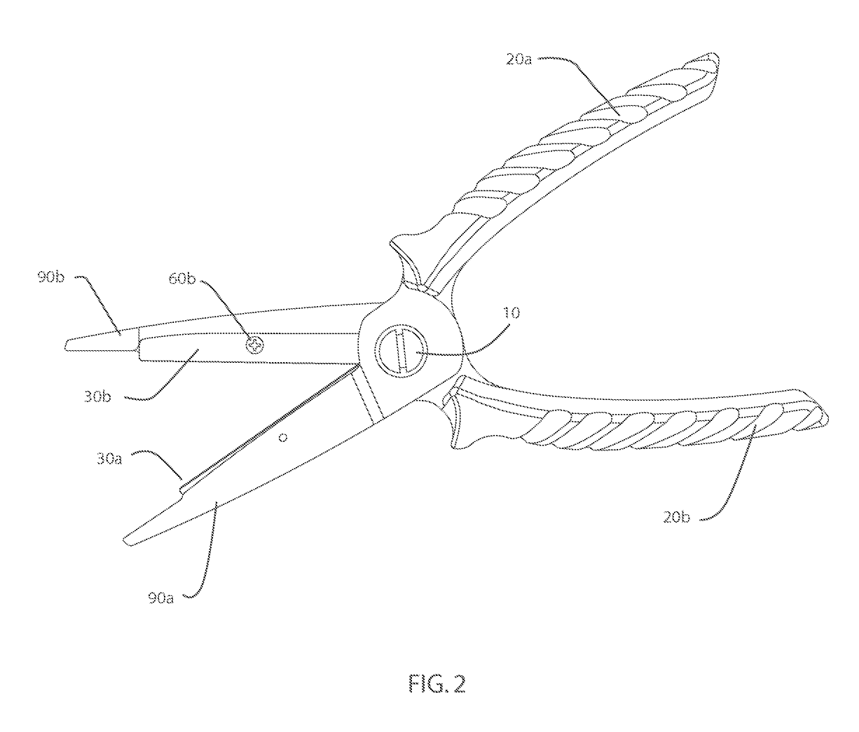

FIG. 2 shows an assembled side view of the tool of FIG. 1 in the open position. Blades 30a and 30b attach to arms 90a and 90b via removable screws. 60b shown, at the blade end. Handles 20a and 20b are shown attached to arms 90a and 90b at the handle end. Pivot fastener 10 is visible, connecting arms 90a and 90b, but interior parts are hidden.

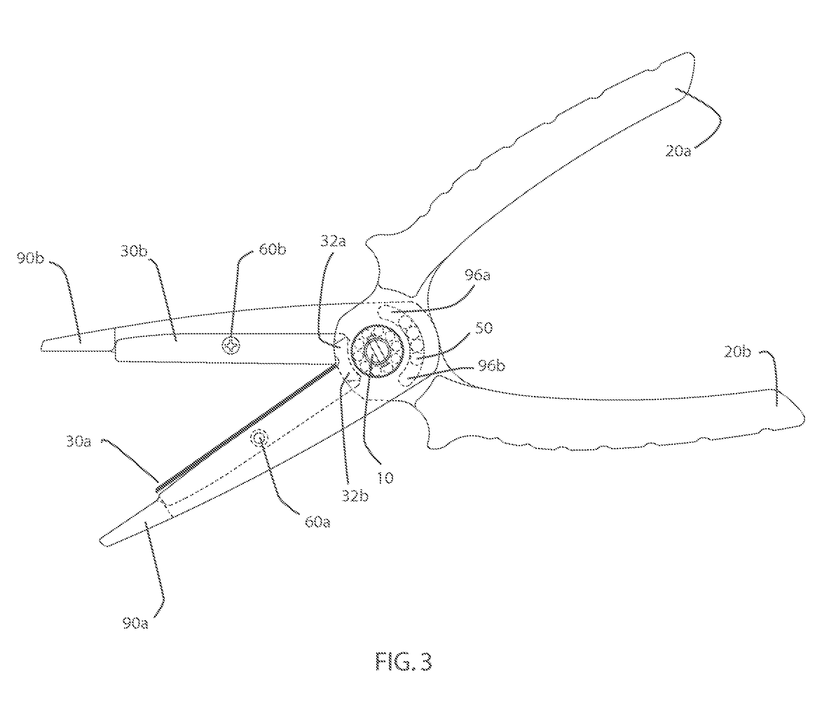

FIG. 3 shows a side view of the tool in the open position, in the same orientation as in FIG. 2, with some hidden parts shown in dotted lines. Ride bearings 50 are positioned within the arcuate tracks 96a and 96b of the arms 90a and 90b between the pivot fastener 10 and the handles 20a and 20b. Adjacent to the pivot fastener 10 along the blade end are shown the blade feet 32a and 32b in contact with each other near the pivot. In this figure, removable screw 60a is visible in addition to screw 60b.

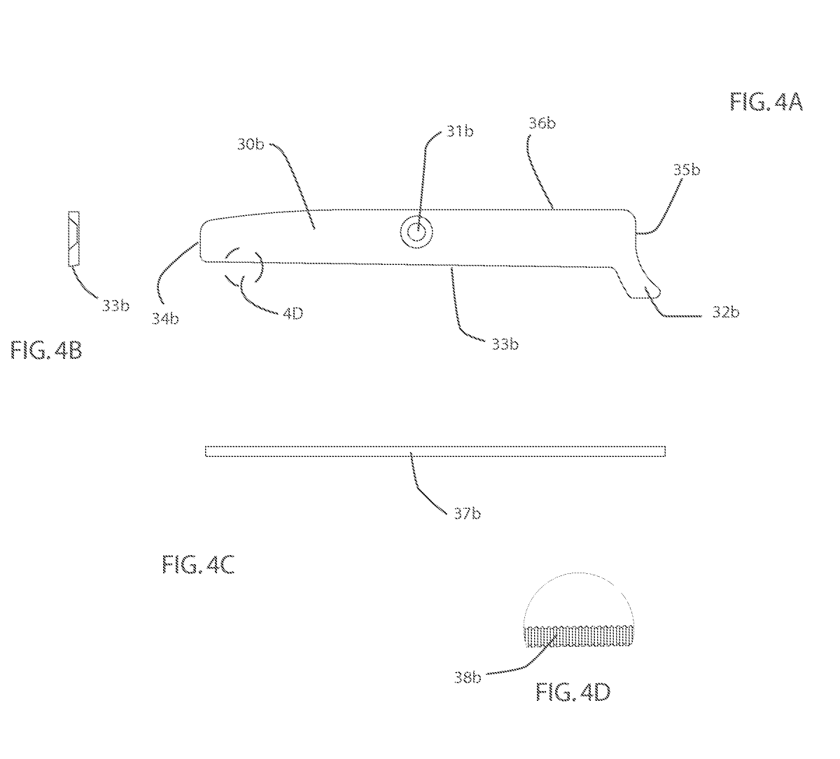

FIGS. 4A-4C show a side view, a section view through a central opening 31b, and a top view, respectively, of the blade 30b. Shown are the distal tip 34b, tang 35b, top flat edge 36b, foot 32b, sharp cutting edge 33b, and chamfered through-hole 31b which accepts the removable screw 60b for attachment of the blade 30b to the arm 90b.

FIG. 4D shows micro serrations on the blade edge 33b. In embodiments, one blade may be serrated and the other smooth, both may be smooth, or both may be serrated.

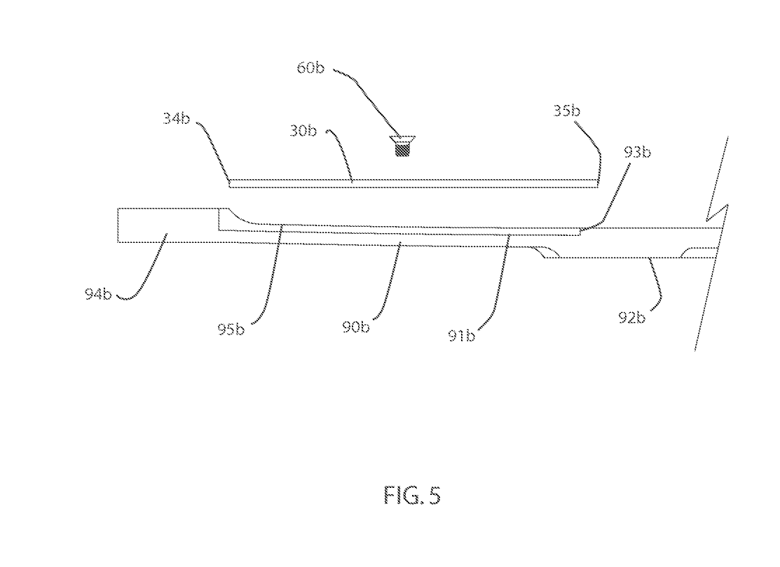

FIG. 5 shows a top view exploded view of the blade 30b into the arm pocket 91b. The blade 30b is flat in its resting state, while the pocket 91b on arm 90b has a bend forming a concave shape within the pocket 91b. As screw 60b is tightened securing the blade 30b to the arm 90b, the tightening action causes the blade 30b to bow into the concave pocket within the arm 90b. The bend in the two blades 30a and 30b forms the draw, and permits the two blades to remain in contact throughout the cutting action of the tool. The opposed bent members of arms 90a and 90b act as springs pressing blades 30a and 30b against one another. Moreover, the fact that the blades 30a and 30b are straight aids in inexpensive manufacture of the blades. Note that the blade 30a inserts into curved pocket 91a in arm 90a in precisely the same manner as described above for blade 30b, into pocket 91b on arm 90b.

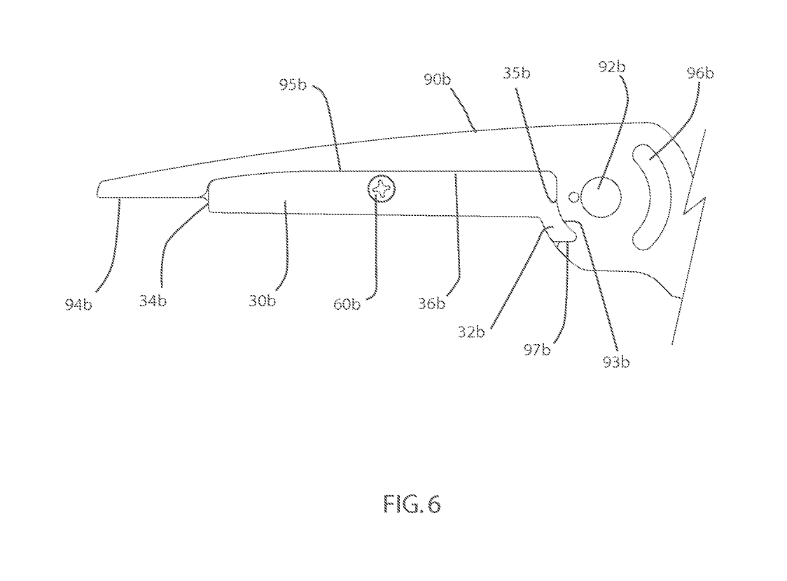

FIG. 6 shows a left view of the blade 30b mounted to the arm 90b (without showing arm 90a, which would cover parts of arm 90b in this orientation). The blade is held in position by screw 60b when couched within the pocket 91b. The blade top edge 36b is supported against arm pocket edge 95b and blade tang 35b against arm pocket 93b. The blade foot 32b is held within arm notch 97b. Ordinarily, the arm notch 97b and blade tang 35b are covered by arm 90a and by blade foot 32a (not shown). When fully open, the blade feet 32a and 32b are in contact and run antiparallel, with each blade foot extending roughly halfway across the opposite blade tang. Thus, during assembly, each blade must be inserted longitudinally into the arm notches 97a and 97b before being secured and tightened in place with the screws 60a and 60b. One ride bearing pocket 96b is also shown, as well as pivot socket 92b.

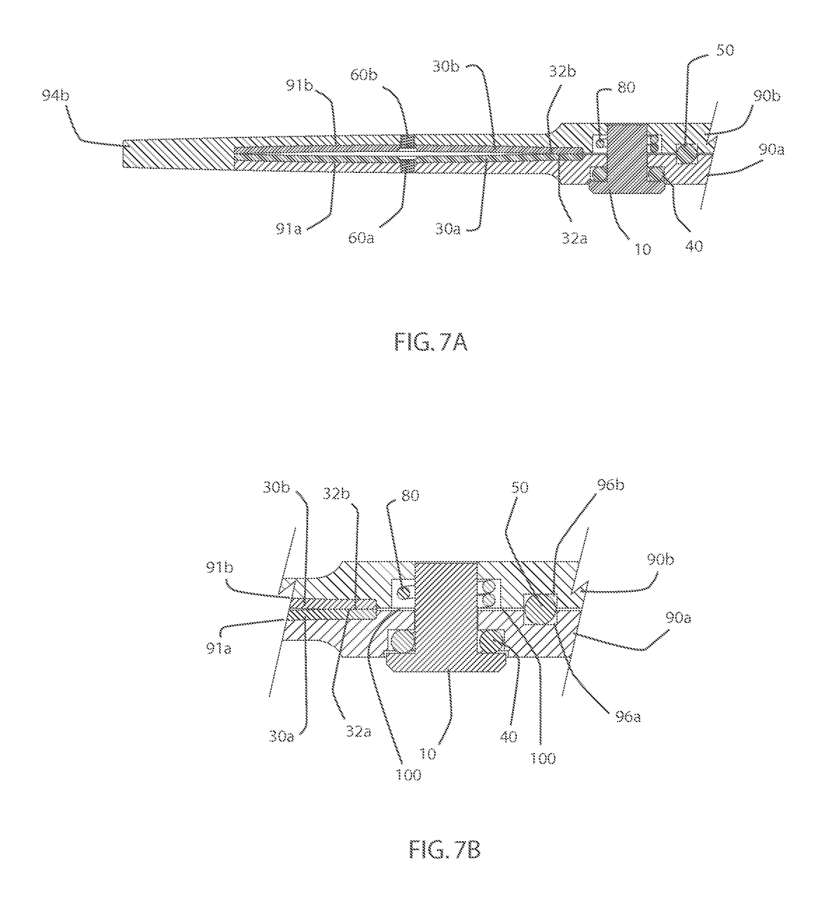

FIG. 7A shows a top section view of the assembly in the closed position. As can be seen, the curved pockets 91a and 91b cause the two blades 30a and 30b to bow, with the screws 60a and 60b holding the two blades 30a and 30b in place. The bow forms an arc in each of the blades along the longitudinal direction (left-to-right), but the blades do not bend or tilt inward along the transverse direction (into the page) at their cutting edges. The flexure of the arms 90a and 90b in the blade region allows the severity of this bow to vary as the scissor arms move between the open and closed positions to minimize the gap behind the contact point as the blades close.

FIG. 7B shows a detail top section view of the pivot assembly in accordance with embodiments. The pivot fastener 10 is fastened through arm 90a to the arm 90b, for example by threads. In other embodiments, the pivot fastener may pass entirely through holes in both arms and attach to a nut outside arm 90b, which may include washers and may be locking or configured for disassembly. In embodiments, the head end of the pivot fastener 10 may rotate relative to the arm 90a proximate to the pivot fastener head, and the threaded end may attach to receiving threads in the arm 90b opposite. In some embodiments, the arm 90b may be threaded to receive the fastener, and also incorporate a locking nut to secure the pivot fastener.

The pivot fastener 10 forces the arms 90a and 90b against each other. In some embodiments, the pivot fastener 10 rides on bearings 40 in a circular track about the through hole 92a in arm 90a, serving to reduce friction as the blades rotate, which allows for greater tension and rigidity in the pivot without than would otherwise be possible without bearings, and minimizes the force acting to loosen or unscrew the pivot fastener during opening and closing of the scissor arms. In alternative embodiments, the pivot fastener 10 may ride on washers which may be configured to reduce friction, for instance by being composed of a friction reducing material such as MYLAR polyester films, although other friction-reducing materials or surfaces may be equivalent. Some embodiments have two washers disposed between the head of the pivot fastener 10 and the outer surface of the moving arm 90a, with receiving threads in the static arm 90b, and a locking washer opposite the static arm 90b. Washers, like bearings, reduce friction, permitting greater tension in the fastener without restricting usability.

Ride bearings 50 support the alignment of the arms 90a and 90b and press the proximal, handle ends of the arms away from each other, driving the distal or blade ends of the arms together so that the blade feet 32a and 32b are always in tight contact, along with the edge contact point along the blades, and further supporting the rigidity of the pivot 10. There is a small gap 100 between the arms at the pivot area so that, when the scissors are fully opened, only the blade feet 32a and 32b are in contact with each other. This gap allows the blades 30a and 30b to be biased into contact as the handles are opened and closed. In some embodiments, a spring 80 is provided about the pivot fastener 10 which presses the blades into the open position, such that a user will only have to exert force to close the blades, but not to reopen them. Other embodiments may lack this spring, particularly those that include alternative means for opening the scissors, such as handle loops.

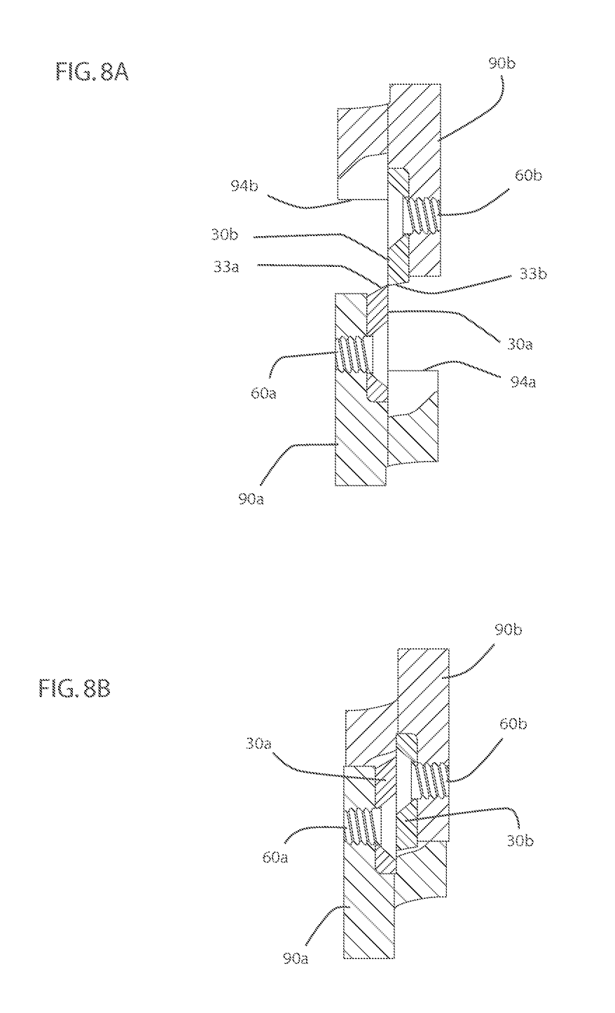

FIG. 8A is a front section view of the scissors assembly with edges coming into contact with each other. Because the blades extend straight up and down in the transverse direction (vertical on page) and bend at an arc longitudinally (into the page) but do not tilt inward at their contact edges, the blades 30a and 30b are parallel with each other at the contact point of the edges 33a and 33b, and through a cross section of the arms at the contact point, and remain substantially parallel immediately before and after the contact point having no helical turn or twist. This orientation differs from the blade orientation found in most scissors, in which the blades are held at an angle to each other, with the cutting edges contacting and the upper and lower parts of the arms, above and below the contact points, spaced from each other. Thus, in a tool of the present disclosure, a cross section of the blades taken perpendicular to the arms at the location of a cut shows the blades parallel to each other, as shown in FIG. 8A. This parallel orientation remains throughout cutting, as shown in FIG. 8B. Furthermore, the blades are also parallel to the shear plane and to the direction of the cutting motion.

FIG. 8B is a front section view of the scissors assembly with blades 30a and 30b in the closed position. Notably, the gap between the blades between the tip and the foot in the closed position is narrow, due to the substantially parallel geometry of the blades, the flexibility of the blade regions of the arms 90a and 90b, and the high degree of rigidity at the pivot.

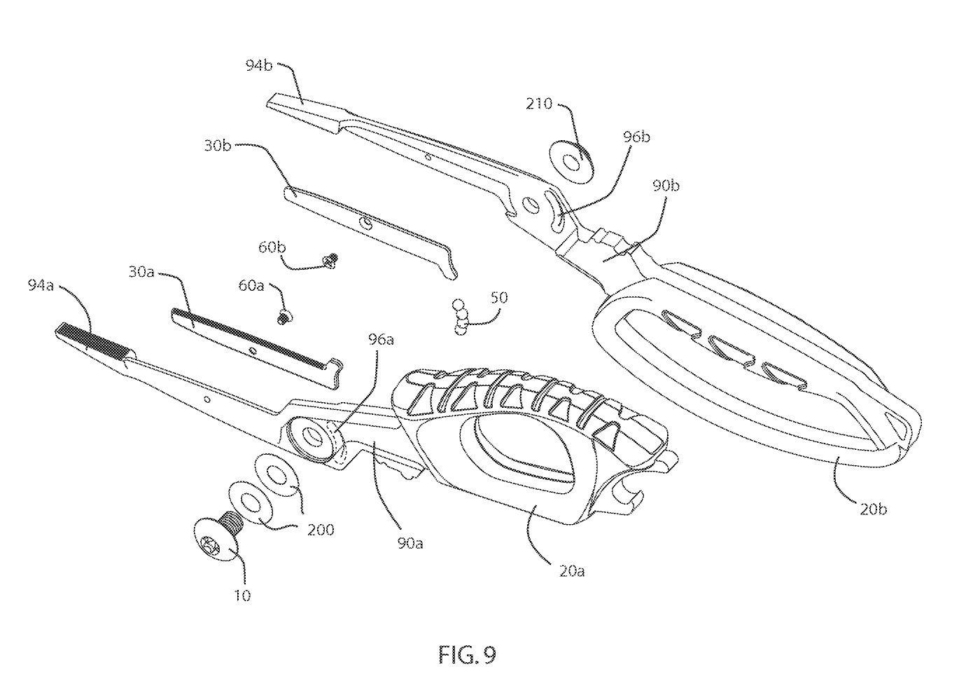

FIG. 9 shows an alternate embodiment of the scissors tool in an exploded assembly view. Shown are the arms 90a and 90b that have handles 20a and 20b with thumb and finger loops. The spring 80 shown in FIG. 1, FIG. 7A and FIG. 7B is absent in this and related embodiments, being reduced in importance in embodiments where the handles 20a and 20b have finger and thumb loops that permit ease of manual opening as well as closing of the scissors assembly. The cutting blades 30a and 30b are held in place on the arms by screws 60a and 60b respectively. Ride bearings 50 are shown and the tracks 96a and 96b with in the arms 90a and 90b can receive the ride bearings 50. Also shown is the pivot fastener 10, washers 200 and nut 210 used to hold the arms 90a and 90b together and provide an axis about which the arms 90a and 90b can pivot. As detailed above, the arm 90b may be threaded to receive the pivot fastener 10, with locking nut 210 used to secure the pivot fastener to arm 90b. Note also the absence of bearings about the pivot fastener 10; however, washers 200 may be either conventional or low-friction washers performing a similar function to bearings.

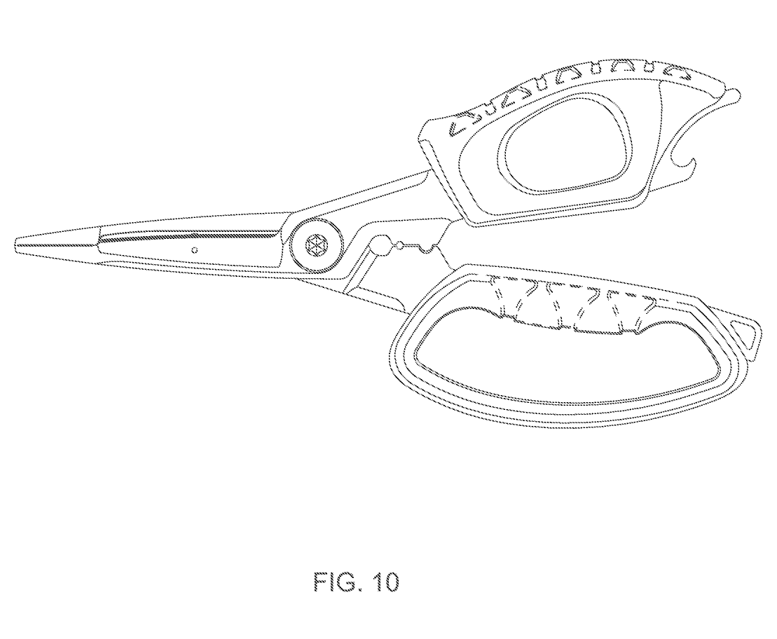

FIG. 10 is left view of an alternate embodiment of the scissors tool assembly, as described above, with the blades closed. Additional features can also collectively or individually be included in the assembly, such as a wire crimper, a bottle opener, or a hanging loop. The finger and thumb loops may additionally include a textured outer surface to enable a more powerful squeezing grip that uses the heel of the hand, rather than the thumb.

### Description of the Operation of the Scissors Tool

Operation of the tool will now be described. As described above, in embodiments, the blades are substantially parallel in the cutting direction, being parallel with the shear plane at all points and having no helical shape or twist. As the blades come into contact when making a cut, the blades slide along each other without a gap. Keeping the blades parallel in the tool helps cut certain materials better by preventing the material from twisting or slipping between the edges as is common in conventional scissors. Moreover, the parallel blades promote shear in the cut material rather than compression or irregular deformation, due to the substantial absence of any gap between the blades and the shear plane. These design elements are particularly important for cutting thick, flexible or strong materials such as, but not limited to, wire, cord, heavy fabric, heavy fishing line, and particularly braided fishing line.

The curved/arced nature of the blades, or the draw, allows the cutting edges to remain in contact through movement of the handles from opened to closed. If the blades were not curved, then there could not be a single point of contact for cutting. As a result of the curvature of the blades, the blades exert pressure against one another and also force the blade arms to deform elastically from more curved to less curved, such that the blade arms curve past one another when the scissors are open, but straighten and run nearly parallel in the longitudinal direction when closed. Conventional scissors typically have an edge bias force of less than one pound, where the edge bias force is the force exerted by one blade against the other at the cutting intersection, measured at the distal end of the blades from the pivot point when the blades are in a closed position. In embodiments of the scissors tool herein disclosed, the edge bias force may exceed one pound. Various embodiments may have edge bias forces exceeding this amount, and in particular embodiments may exceed eight pounds. The curvature of the blades may cause slight separation in the midpoint of the arms when the blades are fully closed, but the curvature and stiffness of the arms are optimized such that the blades remain in close contact at both the contact point and a region immediately around the contact point throughout the cutting action.

The stiffness of the pivot promotes the correct operation of the parallel blades. In embodiments, the provision of ride bearings 50 between the pivot and handle end reinforces the joint, creating a highly stiff pivot with relatively low friction. Conventional scissors do not achieve comparable stiffness at the pivot while retaining ease of manual use. The high pivot stiffness permits greater edge-to-edge pressures between arms 90a and 90b and blades 30a and 30b than possible in conventional scissors, and offsets the force generated by the two arms pressing against one another. Importantly, a user need only generate force in the cutting direction; the blades achieve sufficient edge pressure without any additional orthogonal force. The ride bearings may also form a stop, created by the length of the ride bearing groove and the number and size of the bearings contained therein, thus limiting the degree to which the scissors can be opened to a useful range.

In some embodiments, the provision of bearings 40 about the pivot fastener further reinforces the stiffness of the pivot. Bearings reduce friction between the fastener and the arm 90a, supporting the use of a robust pivot fastener under greater tension than would otherwise be feasible, minimizing out-of-plane deflection of the pivot, and preventing the fastener from loosening under repeated opening and closing motions. In other embodiments, the same functions may be achieved by the provision of washers about the pivot joint. These washers may be composed of low-friction materials or have a low-friction surface treatment.

In summary, embodiments possess blades with an orientation that is parallel to one another and to the shear plane, that are curved toward one another having a draw that is variable with the flexure of the blade region of the scissor arms. The curved nature of the blades and the bias at the distal ends of the blades produced by the ride bearings 50 allow the blades to apply force against each other throughout the cutting rotation of the blades, and for the blades at the point of contact to extend parallel to each other. That is, the blades extend parallel from top to bottom of the arms at the point of contact/cutting and up to the top (or down to the bottom) of the arms, as opposed to tilting inward at the point of contact. Thus, the entire arms move to close contact, with very tight clearance along the arms where the cutting occurs. As described above, this configuration and action permits cutting of some materials without trapping material or causing blade separation.

The above described features overcome limitations of conventional scissors in part by substantially improving the alignment and tightening the clearance of the blades at their point of first contact with the object to be cut, thus isolating shear as the dominant force exerted on the object to be cut. The foregoing features further overcome these limitations by substantially increasing pivot-point stiffness, permitting the use of spring stiffness of the distal/blade ends of the arms 90a and 90b to achieve consistent point-of-contact pressure, while providing for a cutting action that is more closely aligned with the shear plane, and a significantly reduced gap between the arms between the point of contact and pivot. Thus, embodiments achieve excellent cutting edge pressure without sacrificing alignment.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A scissors tool comprising:
a first arm and a second arm coupled about a pivot point for aligning blades positioned on the arms for cutting,
each of the first and second arms including a curved pocket for receiving a removable blade,
each of the removable blades being held in a curved position when installed in the curved pocket, and
wherein the two removable blades are substantially parallel to a shear plane at a cross-section of the two removable blades at a cutting intersection.

2. The scissors tool of claim 1, wherein each of the first and second arms further comprises an arcuate slot between a handle of the respective arm and the pivot point, and further comprising one or more ball bearings positioned between the first and second arms and protruding into the arcuate slots for biasing the blades into contact with one another.

3. The scissors tool of claim 2, wherein the removable blades are straight when not under stress, and bow when attached to the curved pockets.

4. The scissors tool of claim 3 wherein the removable blades are attached to the curved pockets by screws inserted through a counter-bored through-hole in each plate and removably inserted into a threaded hole in each of the first and second arms.

5. The scissors tool of claim 4, wherein:
the pivot point comprises a pivot fastener and a pivot clearance between the first and second arms, the pivot fastener being substantially rigid and subject to a positive tension in an out-of-plane direction throughout the range of motion of the arms; and
the pivot clearance between the first and second arms is constant throughout a range of motion of the arms.

6. The scissors tool of claim 5, wherein one or more of the first and second arms are curved toward the other arm.

7. The scissors tool of claim 6, wherein one or more of the first and second arms comprise a diminishing cross-sectional area, the one or more arms having a larger cross-sectional area at a section proximal to the pivot point and a smaller cross-sectional area at a section distal from the pivot point, wherein a section between the proximal and distal regions overlaps with at least part of the curved pockets.

8. The scissors tool of claim 7, wherein one or more of the first and second arms undergoes an elastic deformation during a closing operation of the scissors, from a more curved geometry when the arms are oriented in an open position, to a less curved geometry when the arms are in a closed position.

9. The scissors tool of claim 8, wherein the elastic deformation presses the blades attached to each of the first and second arms together at the cutting intersection in an opposing manner.

10. The scissors tool of claim 9, wherein each blade further comprises a blade foot, each blade foot being a section of the blade proximate to the pivot point and each blade foot being disposed to abut the blade foot of the opposing blade.

11. The scissors tool of claim 10, wherein each blade foot is in contact with the opposing blade foot throughout a range of motion of the scissor arms.

12. The scissors tool of claim 11, wherein one or more of the blades further comprises a serrated edge

13. The scissors tool of claim 12, wherein one of the blades comprises a serrated edge and the other blade comprises a non-serrated edge.

14. The scissors tool of claim 13, wherein the pivot point further comprises a pivot fastener and one or more washers about the pivot fastener for stiffening the pivot point and reducing friction.

15. The scissors tool of claim 13, wherein the pivot point further comprises a pivot fastener and a circular track and ball bearings about the pivot fastener for stiffening the pivot point and reducing friction.

16. The scissors tool of claim 9, wherein the blades being pressed together exert opposing forces against each other, the opposing forces being greater than eight pounds of force, the force being measured at a distal end of the blades from the pivot point and when the scissor arms are in a closed position.

17. A method of increasing the cutting power of a scissors tool, comprising:
providing for removable blades removably connected to first and second scissors arms, each arm having a blade end, pivot point, and handle end, wherein the removable blades are straight, and the removable blades bow when inserted into curved pockets in the blade end of each of the first and second scissors arms.

18. The method of claim 17, further comprising:
reinforcing the pivot point by inserting a means for spacing and rotary friction reduction about the pivot point, and inserting an arcuate ball-bearing complex comprised of arcuate slots within each arm between the pivot point and the handle end, and one or more ball bearings positioned within both arcuate slots, which bias the blades into contact.

19. The method of claim 18, further comprising:
maintaining a substantially parallel orientation between the blades at a cutting point, wherein the parallel orientation is also parallel to a primary shear plane of a cutting motion of the blades, and wherein the parallel orientation persists throughout a whole range of motion of the scissor arms.

20. A scissors tool comprising:
a first arm and a second arm coupled about a pivot point for aligning blades positioned on the arms for cutting, each of the first and second arms including a curved pocket for receiving a removable blade, each of the removable blades being substantially straight when not under stress, and each of the removable blades being held in a curved position when installed in the curved pocket;
wherein the two removable blades are substantially parallel at a cross-section of the two removable blades at a cutting intersection;
wherein the two removable blades are substantially parallel to a primary shear plane;
a first arcuate slot in the first arm between a handle of the first arm and the pivot point;
a second arcuate slot in the second arm between a handle of the second arm and the pivot point; and
one or more ball bearings positioned between the first arm and the second arm and protruding into the arcuate slots for biasing the blades into contact with one another.
